(19) United States
(12) Patent Application Publication
(10) Pub. No.: US 2019/0161107 A1
(43) Pub. Date: May 30, 2019

(54) STEERING COLUMN FOR VEHICLE

(71) Applicant: MANDO CORPORATION, Pyeongtaek-si (KR)

(72) Inventors: HyunBi KWON, Yongin-Si (KR); Sang Hyun PARK, Yongin-Si (KR)

(21) Appl. No.: 16/200,129

(22) Filed: Nov. 26, 2018

(30) Foreign Application Priority Data
Nov. 28, 2017 (KR) 10-2017-0160312
Nov. 28, 2017 (KR) 10-2017-0160335

(51) Int. Cl. B62D 1/184; B62D 1/187

(52) U.S. Cl. CPC B62D 1/184; B62D 1/187

(57) ABSTRACT

A steering column for a vehicle includes: a lower tube having a distance bracket; a plate bracket supported on both sides of the distance bracket and including a tilt slot hole, through which an adjustment bolt passes, a fixed gear having a first through hole through which the adjustment bolt passes; a movable gear engaged with the fixed gear to rotate with the fixed gear and comprising a second through hole, a second cam disposed on a surface facing the fixed gear, and a protrusion protruding toward the fixed gear from an extension on an outer circumferential side of the movable gear to be supported by an outer circumferential surface of the fixed gear; and an adjustment lever configured to rotate the movable gear during a tilting or telescopic operation.

### CROSS REFERENCES TO RELATED APPLICATIONS

This application claims priority from Korean Patent Application Nos. 10-2017-0160335 and 10-2017-0160312, filed on Nov. 28, 2017 and Nov. 28, 2017, respectively which are hereby incorporated by reference for all purposes as if fully set forth herein.

### TECHNICAL FIELD

The present disclosure relates to a steering column for vehicle (hereinafter simply referred to as a “vehicular steering column”), and more particularly, to a vehicular steering column, in which locking and unlocking are smoothly performed when an adjustment lever for tilting or telescopic operation of the steering column rotates and in which an impact noise due to sudden unlocking of the adjustment lever is eliminated when the adjustment lever is unlocked for tilt or telescope position setting.

### BACKGROUND

Generally, a vehicular steering column includes a lower tube and an upper tube, which are fitted to each other, a distance bracket and a plate bracket that apply a tightening force to the lower tube and the upper tube, a mounting bracket that fixes the steering column to a vehicle body, an adjustment bolt for tilt and telescopic locking and unlocking, a movable gear and a fixed gear that have cams that mesh with each other, and the like.

However, with the conventional vehicular steering column having such a configuration, locking and unlocking cannot be smoothly performed and a rattling sensation occurs during turning of an adjustment lever for tilting operation and telescopic operation.

Further, when the adjustment lever is unlocked in order to set the tilt or telescopic position of the steering column, the adjustment lever is suddenly unlocked, generating a shock noise, which causes discomfort to a user.

### SUMMARY

Exemplary embodiments of the present disclosure disclosed herein (also referred to as “the present embodiments”) have been made under the above-described background. The present embodiments provide a vehicular steering column, in which locking and unlocking are smoothly performed when an adjustment lever for tilting or telescopic operation of the steering column rotates and in which an impact noise due to sudden unlocking of the adjustment lever is eliminated when the adjustment lever is unlocked for tilt or telescope position setting, thereby enhancing a user's feeling in lever operation.

The present embodiments are not limited thereto, and other unmentioned embodiments may be clearly appreciated by those skilled in the art from the following descriptions.

According to an exemplary embodiment of the present embodiment, a vehicular steering column includes: a lower tube having a distance bracket on an outer circumferential surface of the lower tube; a plate bracket supported on both sides of a distance bracket and having a tilt slot hole through which an adjustment bolt passes; a fixed gear having a first through hole through which the adjustment bolt passes, the fixed gear including, on one side thereof, a guide protrusion, which is inserted into the tilt slot hole to be supported, and a first cam disposed on a another side thereof; a movable gear engaged with the fixed gear to rotate and including a second through hole, through which the adjustment bolt passes, and a second cam disposed on a surface facing the fixed gear to be engaged with the first cam, the movable gear having a protrusion on an outer circumferential side to protrude toward the fixed gear from an extension extending in a radial direction of the movable gear on an outer circumferential side of the movable gear and to be supported by an outer circumferential surface of the fixed gear; and an adjustment lever configured to rotate the movable gear during the tilting or telescopic operation.

According to another exemplary embodiment of the present embodiment, a vehicular steering column includes: a fixing bracket having a first through hole through which an adjustment bolt passes, the fixing bracket including, on one side thereof, an insertion protrusion inserted into and supported in a tilt slot hole of a plate bracket and a first support groove disposed on a remaining side thereof at a position radially spaced apart from the first through hole; a rotary plate engaged with the fixing bracket to be rotated and including a second through hole through which the adjustment bolt passes and a second support groove disposed at a position opposite the first support groove on the surface facing the fixing bracket; a rotary support rod supported by the first support groove and the second support groove at both ends thereof between the fixing bracket and the rotary plate; and an adjustment lever configured to rotate the rotary plate at the time of a tilting or telescopic operation.

As described above, according to the present embodiments, in the steering column of the vehicle, locking and unlocking can be smoothly performed when the adjustment lever rotates for the tilting or telescopic operation of the steering column.

In addition, according to the present embodiments, impact noise due to the sudden unlocking of the adjustment lever is eliminated when the adjustment lever is unlocked for setting the tilt or telescopic position, thereby enhancing the user's feeling in lever operation.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a perspective view of a vehicular steering column according to an exemplary embodiment of the present embodiment;

FIG. 2 is an exploded perspective view of the vehicular steering column according to an exemplary embodiment of the present embodiment;

FIGS. 3 and 4 are exploded perspective views each illustrating a portion of the vehicular steering column according to an exemplary embodiment of the present embodiment;

FIGS. 5 and 6 are side views illustrating locked and unlocked states of the vehicular steering column according to an exemplary embodiment of the present embodiment;

FIG. 7 is a side view illustrating a portion of the vehicular steering column according to an exemplary embodiment of the present embodiment;

FIGS. 8 and 9 are perspective views each illustrating a vehicular steering column according to another exemplary embodiment of the present embodiment;

FIG. 10 is an exploded perspective view of the vehicular steering column according to another exemplary embodiment of the present embodiment;

FIGS. 11 and 12 are exploded perspective views each illustrating a portion of the vehicular steering column according to another exemplary embodiment of the present embodiment;

FIG. 13 is a side view illustrating a portion of the vehicular steering column according to another exemplary embodiment of the present embodiment;

FIG. 14 is a side view illustrating locked and unlocked states of the vehicular steering column according to another exemplary embodiment of the present embodiment; and

FIG. 15 is a side view illustrating a portion of the vehicular steering column according to another exemplary embodiment of the present embodiment.

### DETAILED DESCRIPTION OF THE EXEMPLARY EMBODIMENTS

Hereinafter, exemplary embodiments of the present disclosure will be described in detail with reference to the accompanying drawings. In adding reference numerals to elements in each drawing, the same elements will be designated by the same reference numerals, if possible, although they are shown in different drawings. Further, in the following description of the present disclosure, a detailed description of known functions and configurations incorporated herein will be omitted when it may make the subject matter of the present disclosure rather unclear.

In addition, terms, such as first, second, A, B, (a), (b) or the like may be used herein when describing components of the present disclosure. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

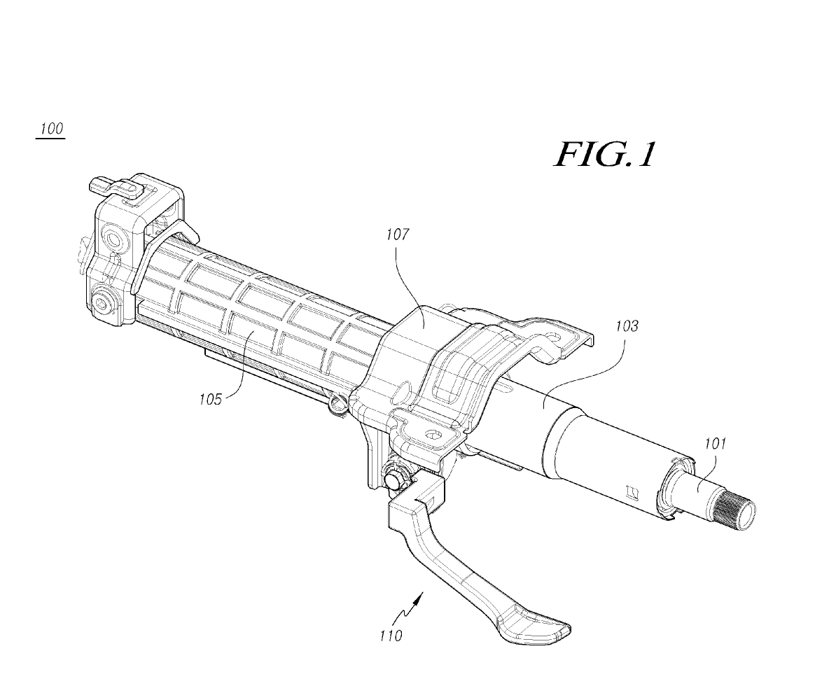

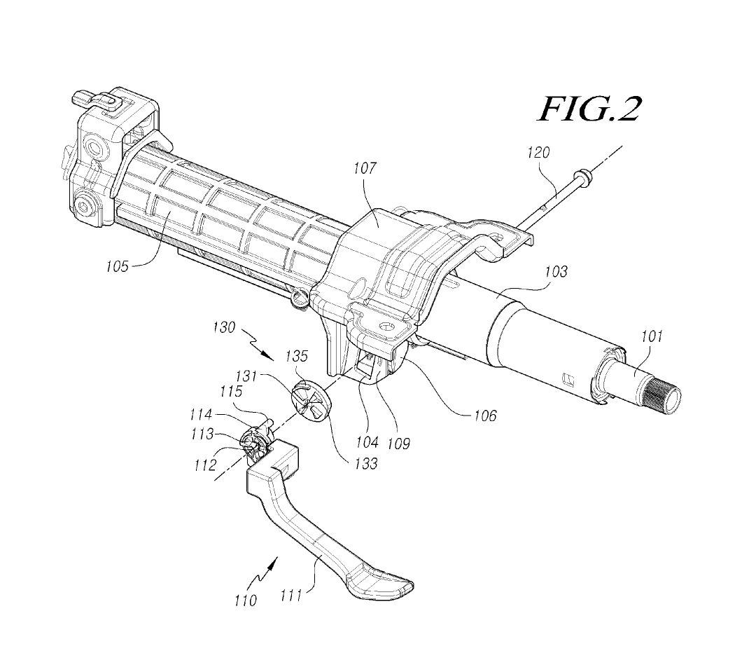

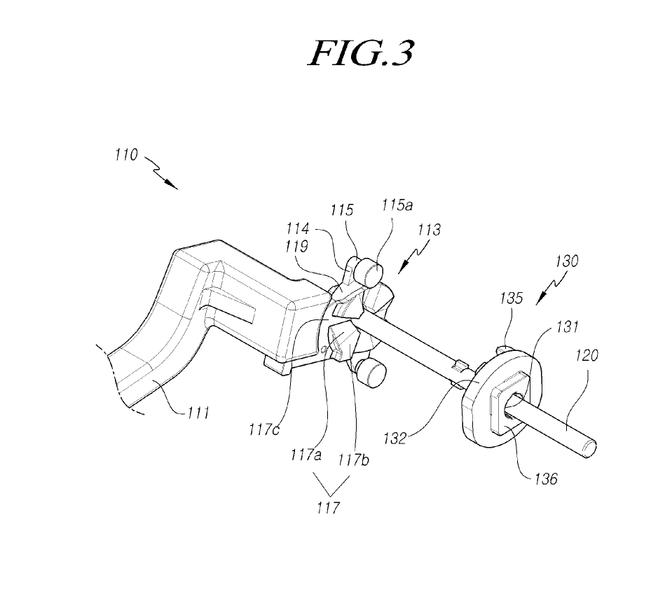

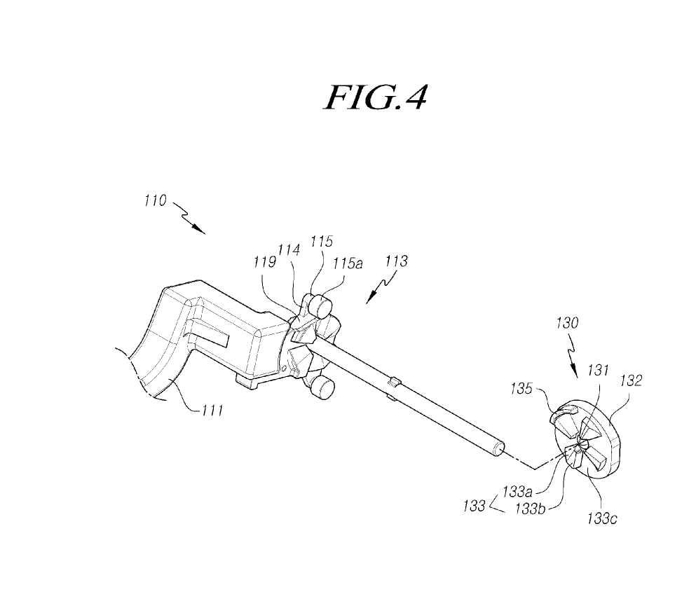

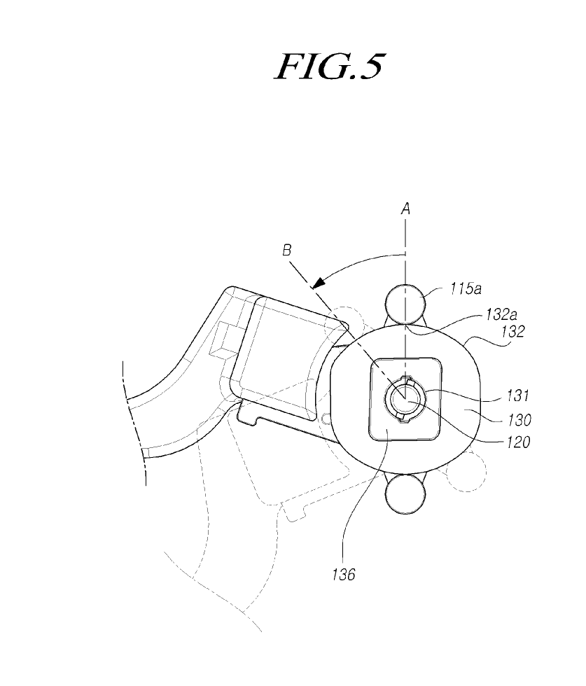

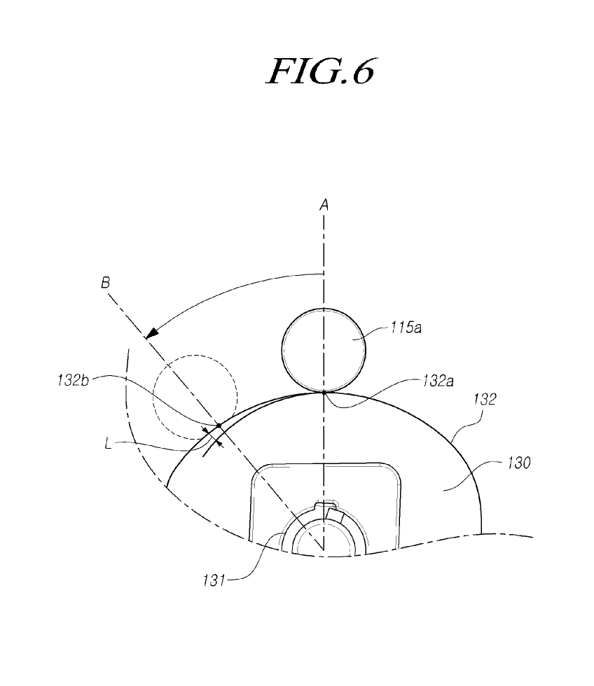

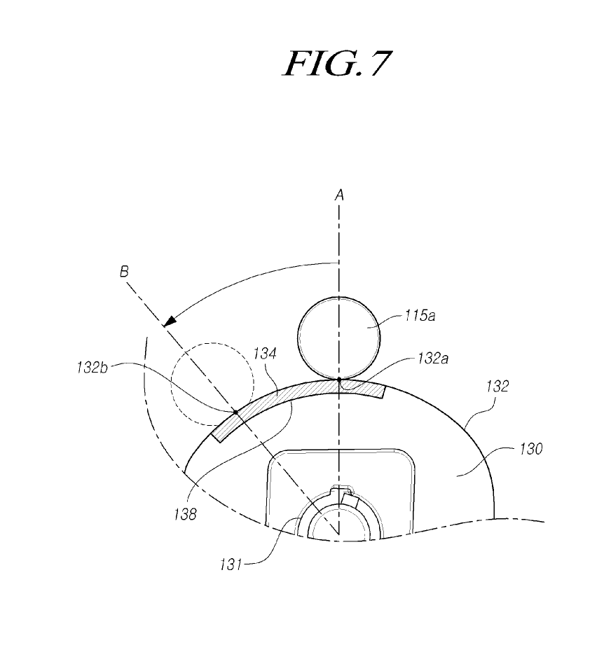

FIG. 1 is a perspective view of a vehicular steering column according to an exemplary embodiment of the present embodiment, FIG. 2 is an exploded perspective view of the vehicular steering column according to an exemplary embodiment of the present embodiment, FIGS. 3 and 4 are exploded perspective views each illustrating a portion of the vehicular steering column according to an exemplary embodiment of the present embodiment, FIGS. 5 and 6 are side views illustrating locked and unlocked states of the vehicular steering column according to an exemplary embodiment of the present embodiment, and FIG. 7 is a side view illustrating a portion of the vehicular steering column according to an exemplary embodiment of the present embodiment.

Referring to FIGS. 1 to 6, a vehicular steering column 100 according to an exemplary embodiment of the present embodiment may include: a plate bracket 109 supported on both sides of a distance bracket 106 provided on an outer circumferential surface of a lower tube 105 and having a tilt slot hole 104 through which an adjustment bolt 120 passes; a fixed gear 130 having a first through hole 131 through which the adjustment bolt 120 passes, the fixed gear 130 including a guide protrusion 136, which is inserted into the tilt slot hole 104 to be supported, on one side thereof, and a first cam 133 disposed at a remaining side thereof; a movable gear 113 engaged with the fixed gear 130 so as to rotate and including a second through hole 112, through which the adjustment bolt 120 passes, and a second cam 117 disposed on a surface facing the fixed gear 130 to be engaged with the first cam 133, the movable gear 113 being provided with a protrusion 115 on an outer circumferential side to protrude toward the fixed gear 130 from an extension 114 extending in a radial direction and to be supported by an outer circumferential surface 132 of the fixed gear 130; and an adjustment lever 110 configured to rotate the movable gear 113 during a tilting or telescopic operation.

The upper tube 103 and the lower tube 105 each has a tube shape having a hollow therein and are fitted to each other to be capable of performing telescopic movement in an axial direction, and a steering shaft 101 is built therein.

In addition, distance brackets 106 may be provided on the outer circumferential surface of the lower tube 105 at positions opposite each other at both sides in the radial direction of the lower tube 105.

The plate bracket 109 is supported and coupled to opposite sides of the distance brackets 106 to apply or remove a pressure so as to tighten or release the plate bracket 109 and the distance brackets 106 when locking or unlocking the adjustment lever 110.

The plate bracket 109 is coupled to a mounting bracket 107 so as to be fixed to a vehicle body, and the tilt slot hole 104 is disposed in the plate bracket 109 such that the adjustment bolt 120 passes through the tilt slot hole 104 to be capable of performing tilt rotation while being supported.

In addition, the adjustment lever 110, the fixed gear 130, and the like are coupled to the adjustment bolt 120 on one side of the plate bracket 109 so that the adjustment lever 110 can be operated.

The fixed gear 130 has the first through hole 131, through which the adjustment bolt 120 passes, and is coupled to the tilt slot hole 104. The fixed gear 130 includes the guide protrusion 136, which is inserted into the tilt slot hole 104 to be supported during the tilting operation, on one side thereof, and the first cam 133 disposed at a remaining side thereof.

The guide protrusion 136 protrudes from one side of the fixed gear 130 and is inserted into the tilt slot hole 104. Both side surfaces of the guide protrusion 136 are adapted to move up and down while being supported on both sides of the tilt slot hole 104 during the tilting operation.

The adjustment lever 110 is provided with a handle 111 that can be gripped by the user and the movable gear 113. The movable gear 113 and the adjustment lever 110 may be integrated with each other.

The second through hole 112, through which the adjustment bolt 120 passes, is disposed in the movable gear 113, which is engaged with the fixed gear 130. The second cam 117 is disposed on the surface of the movable gear 113 that faces the fixed gear 130 to be engaged with the first cam 133.

Therefore, when the adjustment lever 110 is locked or unlocked, the rotation is performed about the adjustment bolt 120 serving as an axis such that the first cam 133 and the second cam 117 move to protrusion surfaces 133b and 117b or reference surfaces 133c and 117c along inclined surfaces 133a and 117a, which are respectively disposed thereon, and are stopped by respective stop protrusions 119 and 135. At this time, a pressing force in the axial direction is generated due to the difference in height between the protrusion surfaces 133b and 117b from the reference surfaces 133c and 117c.

In addition, the extension 114 extending in the radial direction is disposed on the outer circumferential side of the movable gear 113, and the protrusion 115 protrudes from the extension 114 toward the fixed gear 130 and is supported on the outer circumferential surface 132 of the fixed gear 130.

Two or more extensions 114 and protrusions 115 may be spaced apart from each other in the circumferential direction. As illustrated in FIGS. 3 to 6, the extensions 114 and the protrusions 115 are formed at positions symmetrical to each other on both sides of the second through hole 112 in the radial direction. Therefore, when the adjusting lever 110 is locked or unlocked, the protrusions 115 can be supported on the opposite sides of the adjustment bolt 120 in a balanced manner.

The protrusion 115 may include an elastic cylinder 115a, and the elastic cylinder 115a may be held in close contact with the outer circumferential surface 132 of the fixed gear 130 when the adjustment lever 110 is rotated.

The elastic cylinder 115a may have a hollow shape, having at least one open side, and may be coupled to the outer circumferential surface of the end portion of the protrusion 115. In some cases, the elastic cylinder 115a may be integrally molded at an end of the protrusion 115.

Here, the elastic cylinder 115a may include a material, such as Natural Rubber (NR), Nitrile Butadiene Rubber (NBR), Chloroprene Rubber (CR), Ethylene Propylene Terpolymer (EPDM), Fluorine Rubber (FPM), Styrene Butadiene Rubber (SBR), Chloro-Sulphonated Polyethylene (CSM), urethane, or silicon to have weather resistance and flexibility together with elasticity, thereby performing damping to absorb noise and vibration.

A first support surface 132a supported by the elastic cylinder 115a at the locked position of the adjustment lever 110 and a second support surface 132b supported by the elastic cylinder 115a at the unlocked position of the adjustment lever 110 are provided on the outer circumferential surface 132 of the fixed gear 130.

That is, when the adjustment lever 110 rotates for locking or unlocking, the elastic cylinder 115a moves along the outer circumferential surface 132 of the fixed gear 130, and the position at which the adjustment lever 110 is stopped and supported at the locked position becomes a first support surface 132a, and the position at which the adjustment lever 110 is stopped and supported at the unlocked position becomes a second support surface 132b.

In addition, the distance from the center of the first through hole 131, through which the adjustment bolt 120, which is the center portion of the fixed gear 130, passes to the second support surface 132b is larger than the distance from the center of the first through hole 131 to the first support surface 132a, and in FIG. 6, the distance difference is indicated by “L”.

In addition, the fixed gear 130 is formed such that the radius of curvature of the outer circumferential surface 132 progressively increases from the first support surface 132a to the second support surface 132b. Thus, when the adjustment lever 110 is rotated from the first surface 132a, which corresponds to the locked position of the adjustment lever 110, to the second support surface 132b, which corresponds to the unlocked position of the adjustment lever 110, the shock noise due to the instantaneous unlocking of the adjustment lever 110 is eliminated, thereby enhancing the user's feeling in lever operation.

Accordingly, the outer circumferential surface of the elastic cylinder 115a is also held in contact with the first support surface 132a, and is elastically compressed inwards in the radial direction as going towards the second support surface 132b, which is the unlocked position of the adjustment lever 110.

Conversely thereto, when the adjustment lever 110 rotates from the second support surface 132b, which corresponds to the locked position, to the first support surface 132a, which corresponds to the unlocked position, the radial elastic compression of the elastic cylinder 115a gradually disappears. Thus, only the operating force that moves up to the protrusion surfaces 133b and 117b via the inclined surfaces 133a and 117a of the first cam 133 and the second cam 117 is generated, whereby the operating force required for locking the adjustment lever 110 is maintained without change.

That is, when the adjustment lever 110 is rotated in the locking or unlocking direction, the first cam 133 and the second cam 117 are moved along the inclined surfaces 133a and 117a formed in the direction opposite the rotating direction of the first cam 133 and the second cam 117 so as to be spaced apart from each other by the height of the protrusion surfaces 133b and 117b of the first cam 133 and the second cam 117 in the axial direction of the adjustment bolt 120 or returned to the reference surfaces 133c and 117c. At the time of unlocking, the shock and noise generated as the first and second cams 133 and 117 are suddenly dropped to the inclined surface 133a and 117a from the protrusion surfaces 133b and 117b are reduced, and at the time of locking, the locking is performed without changing the required operating force.

The outer circumferential surface 132 of the fixed gear 130 may include a damper 134 in the region thereof in which the first support surface 132a and the second support surface 132b are included so as to reduce vibration and noise during the operation of the movable gear 113.

Here, the damper 134 may include an elastic material, such as Natural Rubber (NR), Nitrile Butadiene Rubber (NBR), Chloroprene Rubber (CR), Ethylene Propylene Terpolymer (EPDM), Fluorine Rubber (FPM), Styrene Butadiene Rubber (SBR), Chloro-Sulphonated Polyethylene (CSM), urethane, or silicon.

In this case, the damper 134 is integrally injection molded on the outer circumferential surface of the fixed gear 130, or a recess 138 may be formed in the outer circumferential surface of the fixed gear 130 and the damper 134 may be coupled thereto, as illustrated in FIG. 7.

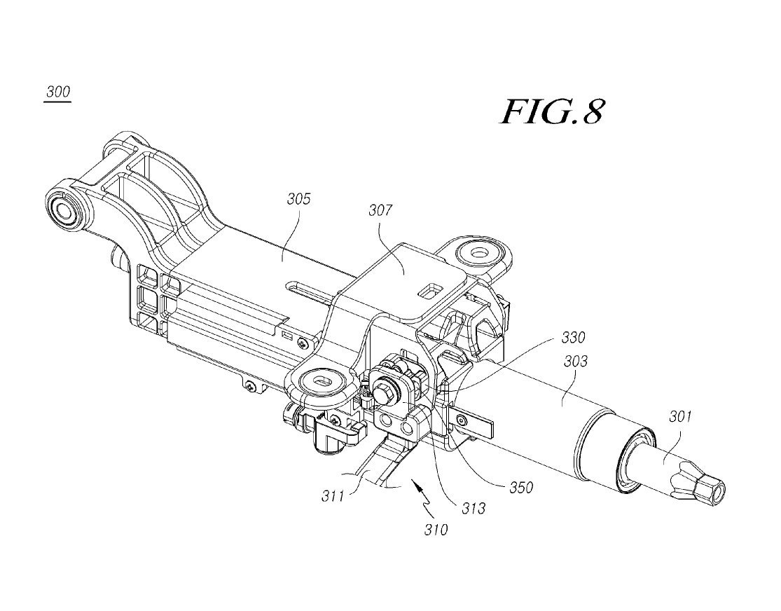

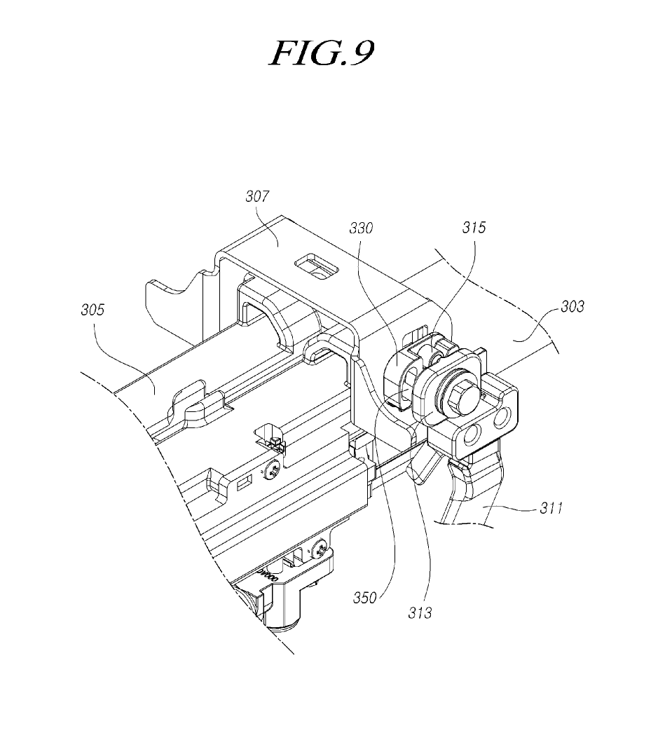

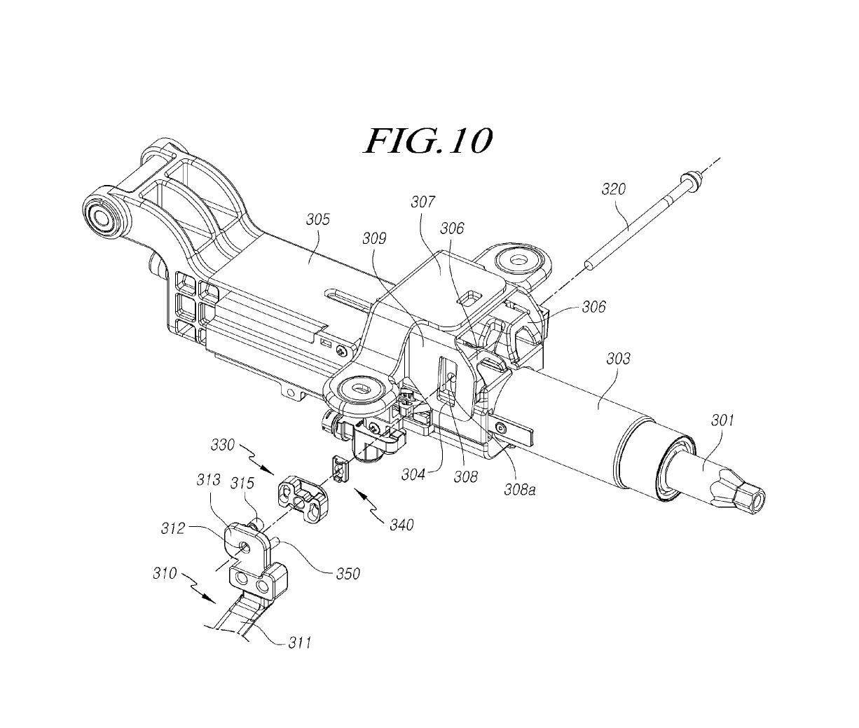

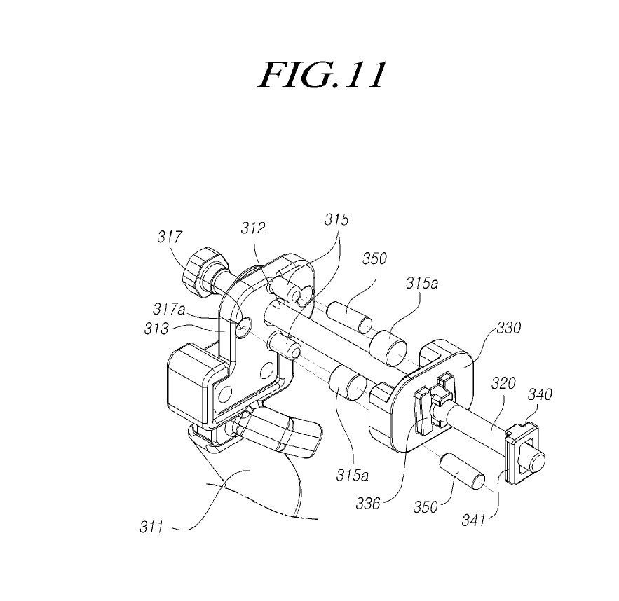

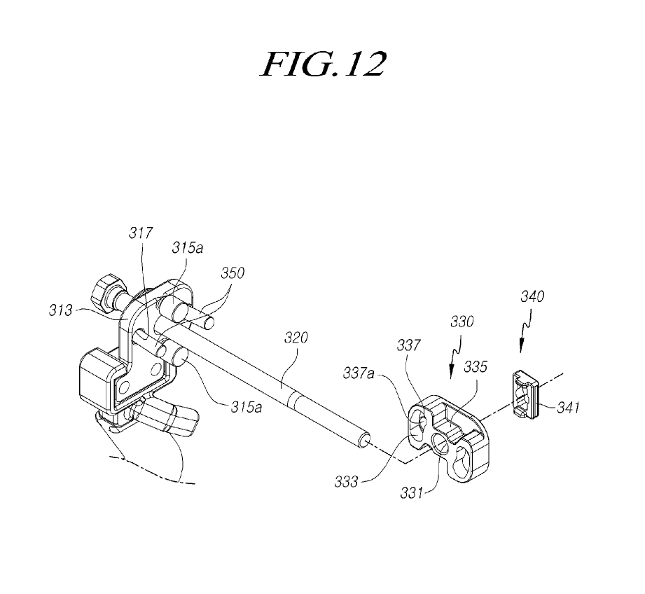

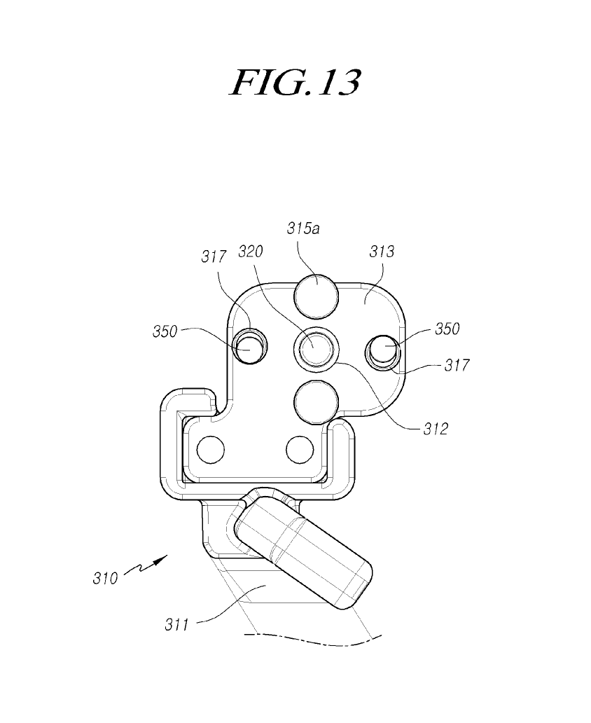

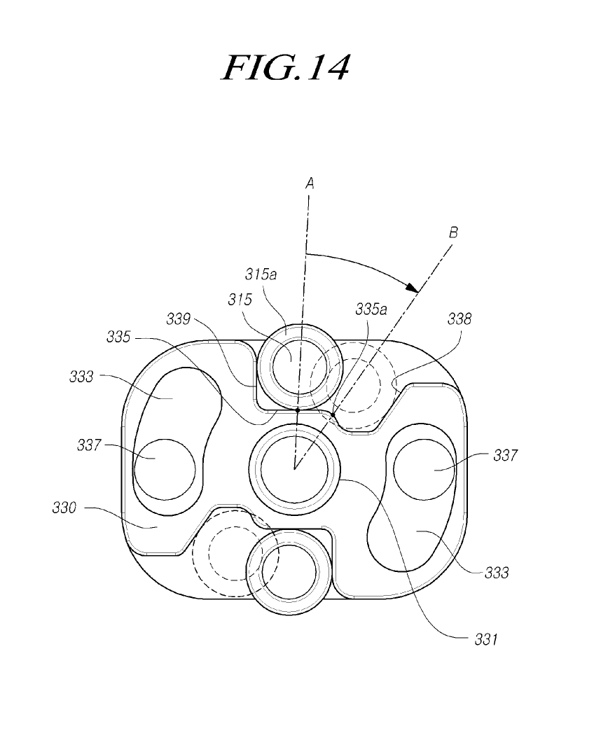

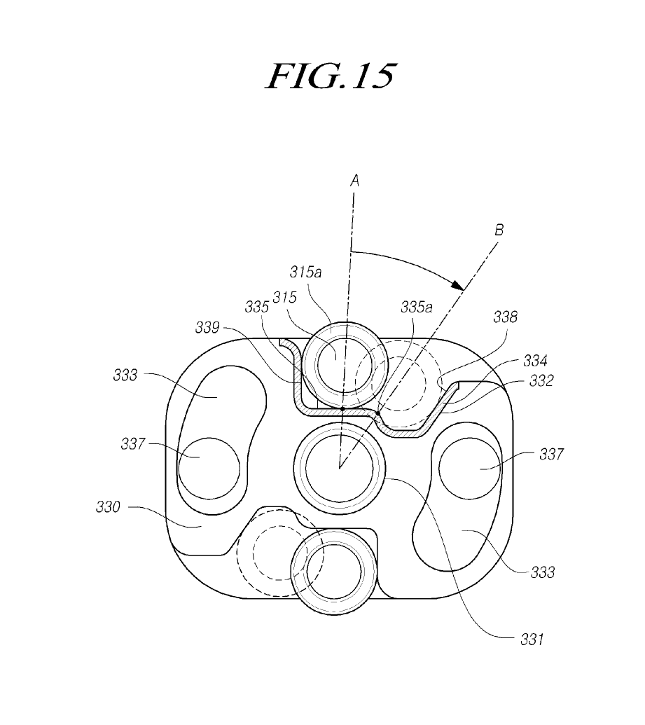

FIGS. 8 and 9 are perspective views of a vehicular steering column according to another embodiment of the present disclosure, FIG. 10 is an exploded perspective view of the vehicular steering column according to another embodiment of the present disclosure, FIGS. 11 and 12 are exploded perspective views each illustrating a portion of the vehicular steering column according to another embodiment of the present disclosure, FIG. 13 is a side view illustrating a portion of the vehicular steering column according to another embodiment of the present disclosure, FIG. 14 is a side view illustrating locked and unlocked states of the vehicular steering column according to another embodiment of the present disclosure, and FIG. 15 is a side view illustrating a portion of the vehicular steering column according to another embodiment of the present disclosure.

Referring to FIGS. 8 to 15, a vehicular steering column 300 according to another embodiment of the present disclosure includes: a fixing bracket 330 having a first through hole 331 through which an adjustment bolt 320 passes, the fixing bracket 330 including, on one side thereof, an insertion protrusion 336 inserted into and supported in a tilt slot hole 304 disposed in a plate bracket 309 and including, on the other side thereof, a first support groove 337 at a position radially spaced apart from the first through hole 331; a rotary plate 313 engaged with the fixing bracket 330 to be rotated and including a second through hole 312 through which the adjustment bolt 320 passes and a second support groove 317 disposed at a position opposite the first support groove 337 on the surface facing the fixing bracket 330; a rotary support rod 350 supported by the first support groove 337 and the second support groove 317 at both ends thereof between the fixing bracket 330 and the rotary plate 313; and an adjustment lever 310 configured to rotate the rotary plate 313 at the time of a tilting or telescopic operation.

An upper tube 303 is inserted into a lower housing 305 so as to be capable of performing an axial telescopic motion, and a steering shaft 301 is built therein.

In addition, distance brackets 306 are provided on the outer circumferential surface of the lower housing 305 at positions opposite each other at both sides in the radial direction of the lower housing 305.

The plate bracket 309 is supported and coupled to opposite sides of the distance brackets 306 to apply or remove pressure so as to tighten or release the plate bracket 309 and the distance brackets 306 when locking or unlocking the adjustment lever 310.

The plate bracket 309 is coupled to a mounting bracket 307 so as to be fixed to the vehicle body, and a tilt slot hole 304 is disposed in the plate bracket 309 such that the adjustment bolt 320 passes through the tilt slot hole 104 so as to be capable of performing tilt rotation while being supported.

In addition, the adjustment lever 310, the fixing bracket 330, the rotary plate 313, and the like are coupled to the adjustment bolt 320 on one side of the plate bracket 309 so that the adjustment lever 310 can be operated.

The fixing bracket 330 has the first through hole 331, through which the adjustment bolt 320 passes so as to be coupled to the tilt slot hole 304. One side of the fixing bracket 330 includes, on one side thereof, the insertion protrusion 336, which is inserted into and supported in the tilt slot hole 304, and includes, on the other side thereof, the first support groove 337 formed at a position radially spaced apart from the first through hole 331.

The damper 340 is coupled to the insertion protrusion 336 of the fixing bracket 330 so as to be supported in the tilt slot hole 304 so that the damper 340 is supported in the tilt slot hole 304, so that shock noise caused by the tilt slot hole 304 can be reduced when the tilt operation is performed.

Here, the damper 340 is coupled to the mounting groove 308 of the distance bracket 306 in which the bolt hole 308a is disposed, and the damper 340 is provided with protrusions 341 on both sides thereof.

When the damper 340 is coupled to the mounting groove 308, the protrusions 341 are supported on both sides of the mounting groove 308 and are elastically compressed and coupled so as not to be released while damping.

The adjustment lever 310 includes a handle 311 that can be gripped by a user and the rotary plate 313 coupled to the fixing bracket 330. The rotary plate 313 and the adjustment lever 310 may be integrated with each other.

The second through hole 312, through which the adjustment bolt 320 passes, is disposed in the rotary plate 313. The second support groove 317 is disposed on the surface of the rotary plate 313 that faces the fixing bracket 330 at a position opposite the first support groove 337.

Both ends of the rotation support rod 350 are supported and coupled to the first support groove 337 and the second support groove 317 between the fixing bracket 330 and the rotary plate 313.

When the adjustment lever 310 rotates about the adjustment bolt 320 as an axis when the adjustment lever 310 is locked or unlocked, a pivotal movement in which the central axis is inclined in the rotating direction of the adjustment lever 310 is performed in the state in which both ends of the rotary support rod 350 are respectively engaged with the first support groove 337 and the second support groove 317.

For example, the central axis of the rotation support rod 350 is held perpendicular to the facing surfaces of the rotary plate 313 and the fixing bracket 330 with reference to the locking position among the locking position and the unlocking position of the adjusting lever 310. When the adjustment lever 310 rotates to the unlocking position from the locked position, the central axis of the rotary support rod 350 is moved so as to be inclined at a predetermined angle from the vertical state.

As the distance between the fixing bracket 330 and the rotary plate 313 is reduced by the inclination of the rotary support rod 350, the tightening force is reduced in the lower housing 305 and the upper tube 303, thereby leading to the unlocked state, in which the tilting and telescopic operations can be performed.

When the adjustment lever 310 rotates from the unlocked position to the locked position, the central axis of the rotary support rod 350 is moved to be perpendicular to the facing surfaces of the fixing bracket 330 and the rotary plate 313. This increases the tightening force in the lower housing 305 and the upper tube 303 as the distance between the fixing bracket 330 and the rotary plate 313 increases, whereby the locking state, in which the tilting and telescopic operations are impossible, is maintained.

The opposite ends of the rotary support rod 350 have convex curved surfaces, and the first and second support grooves 337 and 317 have concave curved surfaces corresponding to the opposite ends of the rotary support rod 350. Thus, the rotary support rod 350 is configured to be capable of smoothly supporting a pivot motion tilted at a predetermined angle without a rattling sensation while being supported in the first support groove 337 and the second support groove 317 during the rotation of the adjustment lever 310.

Here, a first coated area 337a and a second coated area 317a, which are formed of a low-friction material such as polytetrafluoroethylene (PTFE), may be respectively provided in the first support groove 337 and the second support groove 317 so as to reduce the frictional force and the rattling sensation when the rotary support rod 350 pivots.

In addition, the fixing bracket 330 has a receiving groove 333 extending in the circumferential direction at a position radially spaced apart from the first through hole 331, and the first support groove 337 is provided on the inner surface of one end of the receiving groove 333.

Thus, the rotary support rod 350 is configured to provide a space that is required when the rotary support rod 350 performs the pivot motion tilted at a predetermined angle while being supported in the first support groove 337 and the second support groove 317 in the inner space of the receiving groove 333.

That is, the receiving groove 333 extends in the circumferential direction, in which the adjustment lever 310 is rotated about the first through hole 331, and the rotary support rod 350 is received in the inner space of the receiving groove 333 while being inclined in the rotating direction of the adjustment lever 310.

In addition, the rotary plate 313 has a protruding rod 315 protruding toward the fixing bracket 330 at a position spaced apart from the second support groove 317 in the circumferential direction.

In addition, referring to FIG. 14, the fixing bracket 330 includes a first support wall 339 supported on the outer circumferential surface of the protruding rod 315 at the locked position A of the adjustment lever 310 and a second support wall 138 supported on the outer circumferential surface of the protruding rod 315 at the unlocked position B such that the protruding rod 315 is supported by the first support wall 339 and the second support wall 138 at the locked and unlocked positions so that the rotation of the protruding rod 315 can be stopped.

Two or more protruding rods 315 may be provided to be spaced apart from each other in the circumferential direction. As illustrated in FIGS. 14 and 15, the protruding rods 315 are formed at positions symmetrical to each other on both sides of the second through hole 312 in the radial direction. Therefore, when the adjusting lever 310 is locked or unlocked, the protruding rods 315 can be supported on the opposite sides of the adjustment bolt 320 in a balanced manner.

The protruding rod 315 may have an elastic cylinder 315a, and the elastic cylinder 315a may be supported in the first support wall 339 and the second support wall 338 when the adjustment lever 310 is rotated.

The elastic cylinder 315a may have a hollow shape, having one opened side, and may be coupled to the outer circumferential surface of the protruding rod 315. Without being limited thereto, the elastic cylinder 315a may be integrally molded on the protruding rod 315 in some cases.

Here, the elastic cylinder 315a may be formed of a material, such as Natural Rubber (NR), Nitrile Butadiene Rubber (NBR), Chloroprene Rubber (CR), Ethylene Propylene Terpolymer (EPDM), Fluorine Rubber (FPM), Styrene Butadiene Rubber (SBR), Chloro-Sulphonated Polyethylene (CSM), urethane, or silicon to have weather resistance and flexibility together with elasticity, thereby performing damping to absorb noise and vibration.

In addition, the fixing bracket 330 may have a guide insert 335 connecting the inner end of the first support wall 339 and the inner end of the second support wall 338. When the adjustment lever 310 is rotated, the outer circumferential surface of the elastic cylinder 315a is configured to be rotatable while being supported by the guide insert 335.

Here, the guide insert 335 has a pressing protrusion 335a, which convexly protrudes, on the outer circumferential position at a position corresponding to the unlocked position of the adjustment lever 310. Thus, when the adjustment lever 310 is rotated from the first support wall 339, which corresponds to the locked position, to the second support wall 338, which corresponds to the unlocked position, the shock noise generated due to the sudden unlocking of the adjustment lever 110 is eliminated, thereby enhancing the user's feeling in lever operation.

Accordingly, the outer circumferential surface of the elastic cylinder 315a is also held in contact with the first support wall 339, and is elastically compressed inwards in the radial direction as going towards the second support wall 338, which corresponds to the unlocked position of the adjustment lever 310.

On the other hand, when the adjustment lever 310 is rotated from the second support wall 338, which corresponds to the unlocked position, to the first support wall 339, which corresponds to the locked position, the radial elastic compression of the elastic cylinder 315a also gradually disappears, whereby the operating force required for locking the adjustment lever 310 is maintained without change.

That is, when the adjustment lever 310 is rotated in the locking or unlocking direction, the fixing bracket 330 and the rotary plate 313 are spaced apart from or returned to each other in the axial direction of the adjustment bolt 320 by the difference between the height when the rotary support rod 350 is vertical and the height in the state of being tilted at a predetermined angle. At the time of unlocking, the elastic cylinder 315a is elastically deformed in the radial direction by the compression protrusions 335a, so that impact and noise are reduced, and at the time of locking, the locking is performed without a change in required operating force.

In addition, the fixing bracket 330 may be provided with a damper 334 on the outer circumferential surface from the first support wall 339 to the guide insert 335 and the second support wall 338 so as to reduce vibration and noise when the rotary support rod 350 operates.

Here, the damper 334 may be formed of an elastic material, such as Natural Rubber (NR), Nitrile Butadiene Rubber (NBR), Chloroprene Rubber (CR), Ethylene Propylene Terpolymer (EPDM), Fluorine Rubber (FPM), Styrene Butadiene Rubber (SBR), Chloro-Sulphonated Polyethylene (CSM), urethane, or silicon.

In this case, the damper 334 may be integrally injection molded on the outer circumferential surface from the first support wall 339 to the guide insert 335 and the second support 338, or a recess 138 may be formed in the outer circumferential surface of the fixing bracket 330 and the damper 334 may be coupled thereto, as illustrated in FIG. 7.

As described above, according to the present embodiments, in the steering column of the vehicle, locking and unlocking can be smoothly performed when the adjustment lever for tilting or telescopic operation of the steering column rotates.

In addition, according to the present embodiments, impact noise due to the sudden unlocking of the adjustment lever is eliminated when the adjustment lever is unlocked for setting the tilt or telescopic position, thereby enhancing the user's feeling in lever operation.

Although all the elements constituting embodiments of the present disclosure have been described above as being combined into a single unit or combined to be operated as a single unit, the present disclosure is not necessarily limited to such embodiments. That is, at least two elements of all structural elements may be selectively joined and operate without departing from the scope of the present disclosure.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

The above embodiments have been described merely for the purpose of illustrating the technical idea of the present disclosure, and those skilled in the art will appreciate that various modifications and changes are possible without departing from the scope and spirit of the present disclosure. Therefore, the embodiments disclosed in the present disclosure are intended to illustrate the scope of the technical idea of the present disclosure, and the scope of the present disclosure is not limited by the embodiment. The scope of the present disclosure shall be construed on the basis of the accompanying claims in such a manner that all of the technical ideas included within the scope equivalent to the claims belong to the present disclosure.

What is claimed is:

1. A steering column for a vehicle, comprising:
a lower tube having a distance bracket on an outer circumferential surface of the lower tube;
a plate bracket supported on both sides of the distance bracket, wherein the plate bracket has a tilt slot hole, through which an adjustment bolt passes;
a fixed gear having a first through hole through which the adjustment bolt passes, wherein the fixed gear comprises:
a guide protrusion, which is inserted into the tilt slot hole to be supported, on one side of the fixed gear; and
a first cam disposed on another side of the fixed gear;
a movable gear engaged with the fixed gear to rotate with the fixed gear, wherein the movable gear comprises:
a second through hole, through which the adjustment bolt passes;
a second cam disposed on a surface facing the fixed gear to be engaged with the first cam; and
a protrusion protruding toward the fixed gear from an extension, which extends in a radial direction of the movable gear, on an outer circumferential side of the movable gear to be supported by an outer circumferential surface of the fixed gear; and
an adjustment lever configured to rotate the movable gear during a tilting or telescopic operation.

2. The steering column of claim 1, wherein the movable gear integrally extends from the adjustment lever.

3. The steering column of claim 1, wherein the protrusion is provided in plural such that two or more protrusions are spaced apart from each other in a circumferential direction.

4. The steering column of claim 1, wherein the plurality of protrusions are disposed to be symmetrical to each other on both sides in a radial direction of the second through hole.

5. The steering column of claim 1, wherein the protrusion has an elastic cylinder,
wherein the elastic cylinder is in close contact with the outer circumferential surface of the fixed gear when the adjustment lever rotates.

6. The steering column of claim 5, wherein the elastic cylinder has a hollow shape having at least one opened side, and is coupled to an outer circumferential surface of an end portion of the protrusion.

7. The steering column of claim 5, wherein the fixed gear comprises, on the outer circumferential surface thereof:
a first support surface supported by the elastic cylinder at a locked position of the adjustment lever; and
a second support surface supported by the elastic cylinder at an unlocked position of the adjustment lever,
wherein a distance from a center of the first through hole to the second support surface is larger than a distance from the center of the first through hole to the first support surface.

8. The steering column of claim 7, wherein the outer circumferential surface of the fixed gear has a radius of curvature that gradually increases from the first support surface toward the second support surface.

9. The steering column of claim 7, wherein an outer circumferential surface of the elastic cylinder comes into contact with the first support surface and is elastically compressed inwards in the radial direction of the movable gear as going towards the second support surface.

10. A steering column for a vehicle, comprising:
a fixing bracket having a first through hole through which an adjustment bolt passes, the fixing bracket comprising;
an insertion protrusion, on one side of the fixing bracket, inserted into and supported in a tilt slot hole of a plate bracket; and
a first support groove, on another side of the fixing bracket, radially spaced apart from the first through hole;
a rotary plate engaged with the fixing bracket to rotate, and comprising:
a second through hole through which the adjustment bolt passes; and
a second support groove at a position opposite the first support groove on a surface facing the fixing bracket;
a rotary support rod supported by the first support groove and the second support groove at both ends of the rotary support rod between the fixing bracket and the rotary plate; and
an adjustment lever configured to rotate the rotary plate at a time of a tilting or telescopic operation.

11. The steering column of claim 10, wherein the rotary plate integrally extends from the adjustment lever.

12. The steering column of claim 10, wherein both ends of the rotary support rod have convex curved surfaces, and
the first support groove and the second support groove have concave curved surfaces corresponding to the both ends of the rotary support rod.

13. The steering column of claim 10, wherein the fixing bracket has a receiving groove extending in a circumferential direction and radially spaced apart from the first through hole, and
the first support groove is in an inner surface of one end of the receiving groove.

14. The steering column of claim 10, wherein the rotary plate has a protruding rod protruding toward the fixing bracket to be spaced circumferentially apart from the second support groove.

15. The steering column of claim 14, wherein the fixing bracket comprises a first support wall supported on an outer circumferential surface of the protruding rod at a locked position of the adjustment lever and a second support wall supported on the outer circumferential surface of the protruding rod at an unlocked position of the adjustment lever.

16. The steering column of claim 15, wherein the protruding rod includes an elastic cylinder, and
the elastic cylinder is supported on the first support wall and the second support wall of the fixing bracket when the adjustment lever rotates.

17. The steering column of claim 16, wherein the elastic cylinder has a hollow shape, having at least one opened side, and is coupled to the outer circumferential surface of the protruding rod.

18. The steering column of claim 16, wherein the fixing bracket comprises a guide insert to which an inner end of the first support wall and an inner end of the second support wall are connected,
wherein an outer circumferential surface of the elastic cylinder rotates while being supported by the guide insert when the adjustment lever rotates.

19. The steering column of claim 18, wherein the guide insert includes a pressing protrusion protruding convexly on an outer circumferential surface of the guide insert at the unlocked position of the adjustment lever.

20. The steering column of claim 10, wherein the fixing bracket has a damper coupled to the insertion protrusion,
wherein the damper is supported in the tilt slot hole.
